(19) United States
(12) Patent Application Publication
(10) Pub. No.: US 2015/0219879 A1
(43) Pub. Date: Aug. 6, 2015

(54) PHOTOGRAPHIC LENS AND ELECTRONIC APPARATUS

(71) Applicant: Samsung Electronics Co., Ltd., Suwon-si (KR)

(72) Inventors: Liefeng Zhao, Suwon-si (KR); Byung-kwon Kang, Suwon-si (KR)

(21) Appl. No.: 14/534,768

(22) Filed: Nov. 6, 2014

(30) Foreign Application Priority Data
Feb. 3, 2014 (KR) 10-2014-0012218

(51) Int. Cl. G02B 13/00; G02B 9/60

(52) U.S. Cl. CPC G02B 13/0045; G02B 9/60

(57) ABSTRACT

Provided are a photographic lens and an electronic apparatus including the photographic lens. The photographic lens includes a first lens having a negative refractive power; a second lens having a positive refractive power; a third lens having a negative refractive power and an image-side surface that is concave toward an image-side; a fourth lens having a positive refractive power; and a fifth lens having a negative refractive power. The first, second, third, fourth, and fifth lenses are arranged sequentially from an object-side to the image-side. Each of the first, second, third, fourth, and fifth lenses has at least one aspherical surface.

### CROSS-REFERENCE TO RELATED PATENT APPLICATIONS

This application claims the priority benefit of Korean Patent Application No. 10-2014-0012218, filed on Feb. 3, 2014, in the Korean Intellectual Property Office, the disclosure of which is incorporated herein in its entirety by reference.

### BACKGROUND

1. Field

One or more embodiments of the invention relate to a small and wide-angle photographic lens, and an electronic apparatus including the same.

2. Description of the Related Art

Many users use a photographing apparatus that uses a solid-state imaging device such as a Charge-Coupled Device (CCD)-type image sensor or a Complementary Metal-Oxide Semiconductor (CMOS)-type image sensor. The photographing apparatus includes a digital still camera, a video camera, an interchangeable lens camera, or the like. Since the photographing apparatus using the solid-state imaging device may be small, the photographing apparatus has recently been applied to a small information terminal such as a mobile phone, etc. Users demand a photographing apparatus that has a high performance features such as high resolution, a wide angle, etc. Also, many users have become highly proficient in using the photographing apparatus.

In this regard, since the imaging device has a smaller size and more pixels, a photographic lens is required to have high resolution and high performance. However, it is difficult for four or five photographic lenses to realize user-desired high specifications and it is also difficult for the four or five photographic lenses to be mounted on a slim and portable terminal and simultaneously satisfy optical and aberration characteristics.

### SUMMARY

One or more embodiments include a small and wide-angle photographic lens.

One or more embodiments include an electronic apparatus including the small and wide-angle photographic lens.

Additional aspects will be set forth in part in the description which follows and, in part, will become apparent from the description, or may be learned by practice of the presented embodiments.

According to one or more embodiments, a photographic lens includes a first lens having a negative refractive power; a second lens having a positive refractive power; a third lens having a negative refractive power and an image-side surface that is concave toward an image-side; a fourth lens having a positive refractive power; and a fifth lens having a negative refractive power. The first, second, third, fourth, and fifth lenses are arranged sequentially from an object-side to the image-side. Each of the first, second, third, fourth, and fifth lenses has at least one aspherical surface.

The photographic lens may further include an aperture stop arranged between an object-side of the first lens and the second lens.

According to one or more embodiments, a photographic lens includes a first lens having a negative refractive power; a second lens having a positive refractive power; a third lens having a negative refractive power; a fourth lens having a positive refractive power; a fifth lens having a negative refractive power; and an aperture stop arranged between an object-side surface of the first lens and the second lens. The first, second, third, fourth, and fifth lenses are arranged sequentially from an object-side to an image-side. Each of the first, second, third, fourth, and fifth lenses has at least one aspherical surface.

The photographic lens may satisfy the following condition:

RS1/RS2>1,

where RS1 is a radius of curvature of an object-side surface of the first lens and RS2 is a radius of curvature of an image-side surface of the first lens.

The photographic lens may satisfy the following condition:

0.5<FL2/EFL<1,

where FL2 is a focal length of the second lens and EFL is an effective focal length of the photographic lens.

The photographic lens may satisfy the following condition:

0.1<EFL/FL23<1.1,

where EFL is an effective focal length of the photographic lens and FL23 is a combined focal length of the second lens and the third lens.

The photographic lens may satisfy the following condition:

V2−V3>25,

where V2 is an Abbe number of the second lens and V3 is an Abbe number of the third lens.

The photographic lens may satisfy the following condition:

5>TL4/TL3>2,

where TL3 indicates a thickness of the third lens and TL4 indicates a thickness of the fourth lens.

The fifth lens may have an object-side surface that is concave toward the object-side.

An image-side surface of the fifth lens may have at least one inflection point.

The image-side surface of the fifth lens may be concave toward the image-side near an optical axis.

The photographic lens may have an angle of view equal to or greater than 80 degrees.

Each of the first through fifth lenses may have two aspherical lens surfaces.

Each of the first through fifth lenses may be a plastic lens.

The third lens may be a biconcave lens or a meniscus lens.

The first lens may be a meniscus lens that is convex toward the object-side.

According to one or more embodiments, an electronic apparatus includes a photographic lens and an image sensor. The image sensor receives light that has passed through the photographic lens and converts the light into an electrical image signal. The photographic lens includes a first lens having a negative refractive power; a second lens having a positive refractive power; a third lens having a negative refractive power; a fourth lens having a positive refractive power; a fifth lens having a negative refractive power; and an aperture stop arranged between an object-side surface of the first lens and the second lens. The first, second, third, fourth, and fifth lenses are arranged sequentially from an object-side to an image-side. Each of the first, second, third, fourth, and fifth lenses has at least one aspherical surface.

### BRIEF DESCRIPTION OF THE DRAWINGS

These and/or other aspects will become apparent and more readily appreciated from the following description of the embodiments, taken in conjunction with the accompanying drawings in which:

FIG. 1 illustrates a photographic lens, according to a first embodiment;

FIG. 2 illustrates longitudinal spherical aberration, astigmatic field curves, and distortion of the photographic lens according to the first embodiment;

FIG. 3 illustrates a photographic lens, according to a second embodiment;

FIG. 4 illustrates longitudinal spherical aberration, astigmatic field curves, and distortion of the photographic lens according to the second embodiment;

FIG. 5 illustrates a photographic lens, according to a third embodiment;

FIG. 6 illustrates longitudinal spherical aberration, astigmatic field curves, and distortion of the photographic lens according to the third embodiment;

FIG. 7 illustrates a photographic lens, according to a fourth embodiment;

FIG. 8 illustrates longitudinal spherical aberration, astigmatic field curves, and distortion of the photographic lens according to the fourth embodiment;

FIG. 9 illustrates a photographic lens, according to a fifth embodiment;

FIG. 10 illustrates longitudinal spherical aberration, astigmatic field curves, and distortion of the photographic lens according to the fifth embodiment; and

FIG. 11 illustrates an electronic apparatus having a photographic lens, according to an embodiment.

### DETAILED DESCRIPTION

Reference will now be made in detail to embodiments of a photographic lens and an electronic apparatus including the photographic lens, examples of which are illustrated in the accompanying drawings. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

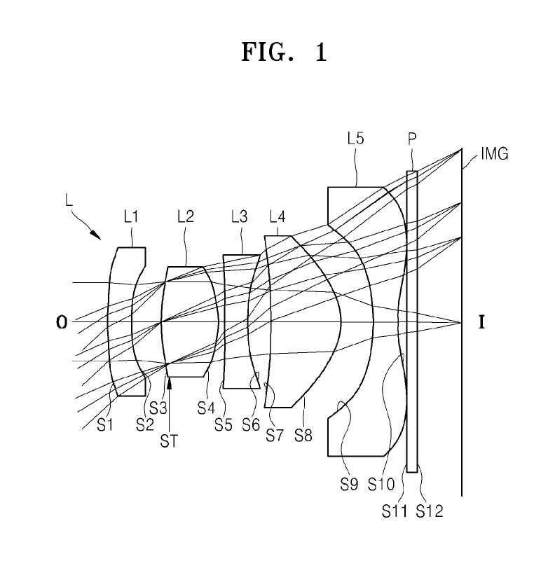

FIG. 1 illustrates a photographic lens L according to an embodiment of the present invention.

The photographic lens L may include a first lens L1 having a negative refractive power, a second lens L2 having a positive refractive power, a third lens L3 having a negative refractive power, a fourth lens L4 having a positive refractive power, and a fifth lens L5 having a negative refractive power, which are arranged sequentially from an object-side O to an image-side I.

An aperture stop ST may be arranged between an object-side of the first lens L1 and the second lens L2. For one example, the aperture stop ST may be arranged between the first lens L1 and the second lens L2. As another example, the aperture stop ST may be arranged at an object-side surface S3 of the second lens L2. A size of the photographic lens L may be decreased by using the aperture stop ST.

The first lens L1 may have an object-side surface S1 that is convex toward the object-side O. The first lens L1 may be a meniscus lens. The object-side surface S3 of the second lens L2 may be convex toward the object-side O. The second lens L2 may be a biconvex lens.

The third lens L3 may have an image-side surface S6 that is concave toward the image-side I. For example, the third lens L3 may be a meniscus lens having a concave surface toward the image-side I or may be a biconcave lens.

The fourth lens L4 may have an object-side surface S7 that is concave toward the object-side O. The fourth lens L4 may have an image-side surface S8 that is convex toward the image-side I. The fifth lens L5 may have an object-side surface S9 that is concave toward the object-side O. An image-side surface S10 of the fifth lens L5 may have at least one inflection point. Here, the inflection point indicates a point at which a sign of a radius of curvature is changed from a positive (+) value to a negative (−) value or from a negative (−) value to a positive (+) value. Alternatively, the inflection point indicates a point at which a concave shape of a lens surface is changed to a convex shape or a convex shape of a lens surface is changed to a concave shape. The image-side surface S10 of the fifth lens L5 may be concave near an optical axis and may be convex as the image-side surface S10 is farther away from the optical axis. The fifth lens L5 may have a biconcave shape near the optical axis.

An image of an object may be incident on an image plane IMG through the first, second, third, fourth, and fifth lenses L1, L2, L3, L4, and L5. The image plane IMG may be a surface of an imaging device or a surface of an image sensor.

At least one optical filter P may be arranged between the fifth lens L5 and the image plane IMG or the image sensor. The optical filter P may include at least one of a low pass filter, an infrared (IR) cut-off filter, and a cover glass. When the optical filter P includes an IR cut-off filter, a visible ray may be transmitted and an infrared ray may be blocked, so that the infrared ray may not reach the image plane IMG. However, the photographic lens L may be configured without the optical filter P.

The first, second, third, fourth, and fifth lenses L1, L2, L3, L4, and L5 may include at least one aspherical lens. For example, each of the first, second, third, fourth, and fifth lenses L1, L2, L3, L4, and L5 may include at least one aspherical surface. For example, each of the first, second, third, fourth, and fifth lenses L1, L2, L3, L4, and L5 may be a bi-aspherical lens which has two aspherical surfaces. By doing so, the photographic lens L may have compactness and high resolution.

At least one of the first, second, third, fourth, and fifth lenses L1, L2, L3, L4, and L5 may be formed as a plastic lens. For example, each of the first, second, third, fourth, and fifth lenses L1, L2, L3, L4, and L5 may be a plastic lens. By forming at least one of the first, second, third, fourth, and fifth lenses L1, L2, L3, L4, and L5 using a plastic material, manufacturing costs may be reduced and an aspherical surface may be easily manufactured.

The photographic lens L according to the present embodiment may satisfy Condition 1 below:

RS1/RS2>1<Condition 1>

where, RS1 is the object-side surface S1 of the first lens L1 and RS2 is an image-side surface S2 of the first lens L1. When (RS1/RS2) satisfies Condition 1, the photographic lens L may receive a light ray with a large incident angle and a wide angle.

The photographic lens L according to the present embodiment may satisfy Condition 2 below:

0.5<FL2/EFL<1 <Condition 2>

where, FL2 is a focal length of the second lens L2 and EFL is an effective focal length of the photographic lens L. When (FL2/EFL) satisfies Condition 2, a height of a light ray with a large incident angle that passes through the first lens L1 and then is incident on the second lens L2 may be decreased, and by doing so, the photographic lens L may have a compact size.

The photographic lens L according to the present embodiment may satisfy Condition 3 below:

0.1<EFL/FL23<1.1 <Condition 3>

where, EFL is an effective focal length of the photographic lens L and FL23 indicates a combined focal length of the second lens L2 and the third lens L3. When (EFL/FL23) satisfies Condition 3, a height of a ray with a large incident angle that passes through the first and second lenses L1 and L2 and then is incident on the third lens L3 may be decreased, and by doing so, the photographic lens L may have a compact size.

The photographic lens L according to the present embodiment may satisfy Condition 4 below:

V2−V3>25 <Condition 4>

where, V2 is an Abbe number of the second lens L2 and V3 is an Abbe number of the third lens L3. When (V2-V3) satisfies Condition 4, chromatic aberration may be easily corrected, so that a high-resolution image may be realized.

The photographic lens L according to the present embodiment may satisfy Condition 5 below:

5>TL4/TL3>2 <Condition 5>

where, TL3 indicates a thickness of the third lens L3 and TL4 indicates a thickness of the fourth lens L4. When (TL4/TL3) satisfies Condition 5, a thickness of the third lens L3 may be reduced, and by doing so, the photographic lens L may have a compact size.

In the present embodiment, an aspherical surface of the photographic lens L is defined as below.

When an X-axis is an optical axis direction and a Y-axis is a direction perpendicular to the optical axis direction, an aspherical shape may be expressed by Equation 6 below and a travel direction of rays may be regarded as being positive. Here, x is a distance from the lens apex in the optical axis direction, y is a distance in a direction perpendicular to the optical axis direction, K is a conic constant, An is an aspherical coefficient, and c is the reciprocal of a radius of curvature (1/R) at the lens apex.

$$x = \frac{{Cy}^{2}}{1 + \sqrt{1 - ( K + 1 ) {C}^{2} {y}^{2}}} + {\sum }_{n = 1}^{6} {Any}^{2 ( n + 1 )} \qquad 〈 Equation 6 〉$$

According to one or more embodiments, the photographic lens L may vary according to various design changes.

In the embodiments, lens-surface numbers S1, S2, S3, . . . , Sn are numbered sequentially from the object-side O toward the image-side I. Here, EFL is the effective focal length of the photographic lens L, FNo is an F-number, FoV is a field of view, R is a radius of curvature, Dn is a lens thickness or an air gap between lenses, Nd is a refractive index, and Vd is an Abbe number. ST is an aperture stop, and * indicates an aspherical surface.

### First Embodiment

FIG. 1 illustrates the photographic lens L according to the first embodiment, and Table 1 shows design data of the first embodiment.

TABLE 1

| Lens surface | R | Dn | Nd | Vd |
|---|---|---|---|---|
| S1* | 6.648 | 0.250 | 1.532 | 55.7 |
| S2* | 2.299 | 0.310 | | |
| S3* (ST) | 2.028 | 0.596 | 1.545 | 56.1 |
| S4* | −1.051 | 0.062 | | |
| S5* | 14.308 | 0.239 | 1.640 | 23.2 |
| S6* | 1.384 | 0.250 | | |
| S7* | −5.429 | 0.729 | 1.545 | 56.1 |
| S8* | −0.631 | 0.345 | | |
| S9* | −1.203 | 0.250 | 1.564 | 37.9 |
| S10* | 1.614 | 0.094 | | |
| S11 | infinity | 0.110 | 1.517 | 64.2 |
| S12 | infinity | 0.438 | | |
| IMG | | 0.032 | | |

Table 2 below shows aspherical coefficients of the photographic lens L according to the first embodiment.

TABLE 2

| Lens | | | | | | | | |
|---|---|---|---|---|---|---|---|---|
| surface | R | K | A1 | A2 | A3 | A4 | A5 | A6 |
| S1* | 6.648 | 5.52E+01 | 2.83E−01 | −2.26E−01 | −8.31E−02 | 2.66E−01 | −2.91E−01 | −1.05E−01 |
| S2* | 2.299 | 0.00E+00 | 6.61E−01 | −7.64E−01 | 2.52E+00 | −3.84E+00 | 0.00E+00 | 0.00E+00 |
| S3* (ST) | 2.028 | 3.14E+00 | 1.86E−02 | −7.67E−01 | 2.04E+00 | −5.63E+00 | 5.10E−07 | 2.80E−08 |
| S4* | −1.051 | −4.07E+00 | 3.36E−02 | −1.81E+00 | 5.02E+00 | −7.17E+00 | −9.80E−07 | −7.10E−08 |
| S5* | 14.308 | 0.00E+00 | −1.38E−01 | −4.61E−01 | 1.81E+00 | −2.12E+00 | 1.60E−06 | 1.30E−07 |
| S6* | 1.384 | 8.35E−01 | −5.07E−01 | 6.84E−01 | −6.14E−01 | 3.15E−01 | −3.06E−03 | −9.80E−07 |
| S7* | −5.429 | 3.72E+01 | −9.50E−02 | 6.07E−01 | −1.31E+00 | 1.08E+00 | 1.19E−01 | −2.20E−02 |
| S8* | −0.631 | −6.19E−01 | 6.93E−01 | −7.02E−01 | 6.45E−01 | 4.68E−01 | −1.37E+00 | 9.16E−01 |
| S9* | −1.203 | −1.30E+01 | −4.49E−02 | −3.59E−01 | 1.63E−01 | 1.57E−01 | −2.27E−01 | 6.13E−02 |
| S10* | 1.614 | 0.00E+00 | −3.70E−01 | 1.83E−01 | −1.14E−01 | 4.04E−02 | −6.83E−03 | −1.00E−05 |

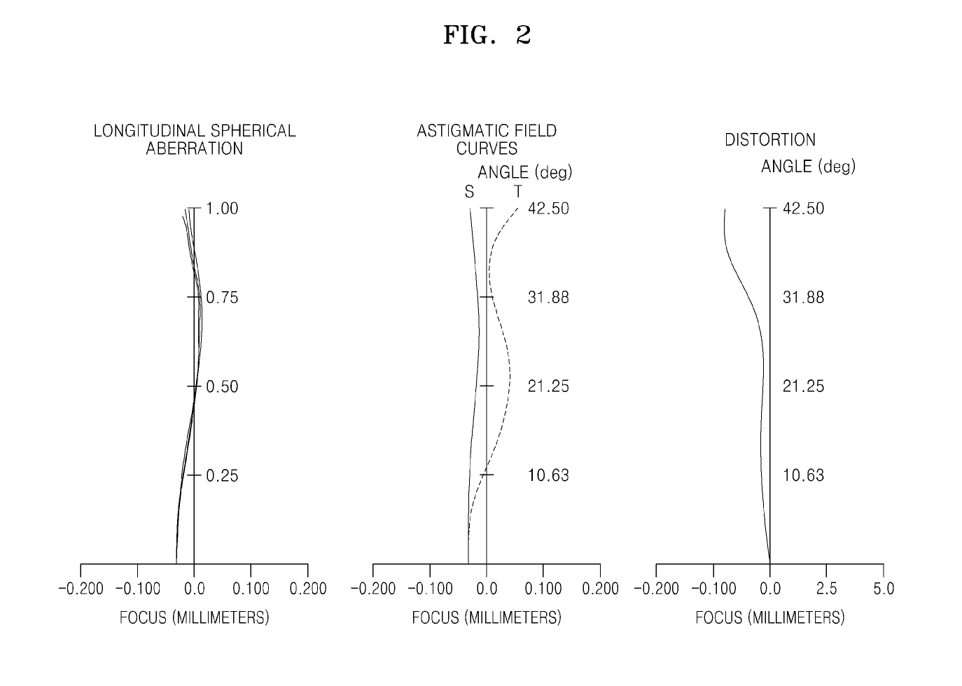

FIG. 2 illustrates longitudinal spherical aberration, astigmatic field curves, and distortion of the photographic lens L according to the first embodiment. The tangential field curvature T and sagittal field curvature S are shown as the astigmatic field curves.

### Second Embodiment

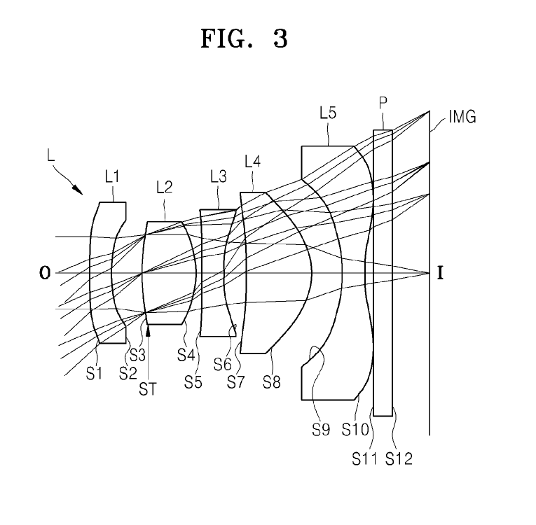

FIG. 3 illustrates a photographic lens L according to a second embodiment, and Table 3 shows design data of the second embodiment.

TABLE 3

| Lens surface | R | Dn | Nd | Vd |
|---|---|---|---|---|
| S1* | 6.475 | 0.250 | 1.532 | 55.7 |
| S2* | 2.178 | 0.340 | | |
| S3* (ST) | 2.035 | 0.600 | 1.545 | 56.1 |
| S4* | −1.042 | 0.068 | | |
| S5* | 10.371 | 0.241 | 1.640 | 23.2 |
| S6* | 1.335 | 0.260 | | |
| S7* | −5.266 | 0.731 | 1.545 | 56.1 |
| S8* | −0.626 | 0.340 | | |
| S9* | −1.228 | 0.250 | 1.569 | 36.1 |
| S10* | 1.623 | 0.097 | | |
| S11 | infinity | 0.210 | 1.517 | 64.2 |
| S12 | infinity | 0.374 | | |
| IMG | | 0.046 | | |

Table 4 below shows aspherical coefficients of the photographic lens L according to the second embodiment.

TABLE 4

| Lens | | | | | | | | |
|---|---|---|---|---|---|---|---|---|
| surface | R | K | A1 | A2 | A3 | A4 | A5 | A6 |
| S1* | 6.475 | 5.16E+01 | 2.91E−01 | −2.29E−01 | −8.82E−02 | 2.74E−01 | −2.60E−01 | −1.05E−01 |
| S2* | 2.178 | 0.00E+00 | 6.77E−01 | −8.39E−01 | 2.59E+00 | −3.56E+00 | 0.00E+00 | 0.00E+00 |
| S3* (ST) | 2.035 | 2.06E+00 | 1.17E−03 | −7.25E−01 | 2.51E+00 | −7.23E+00 | 5.10E−07 | 2.80E−08 |
| S4* | −1.042 | −4.08E+00 | 2.20E−02 | −1.85E+00 | 5.33E+00 | −7.64E+00 | −9.80E−07 | −7.10E−08 |
| S5* | 10.371 | 0.00E+00 | −1.40E−01 | −4.38E−01 | 1.81E+00 | −2.21E+00 | 1.60E−06 | 1.30E−07 |
| S6* | 1.335 | 7.15E−01 | −5.10E−01 | 6.87E−01 | −5.94E−01 | 2.56E−01 | −3.06E−03 | −9.80E−07 |
| S7* | −5.266 | 3.65E+01 | −1.05E−01 | 6.24E−01 | −1.27E+00 | 1.04E+00 | 1.19E−01 | −2.20E−02 |
| S8* | −0.626 | −6.17E−01 | 7.11E−01 | −7.05E−01 | 6.65E−01 | 4.68E−01 | −1.37E+00 | 9.32E−01 |
| S9* | −1.228 | −1.39E+01 | −1.19E−02 | −3.50E−01 | 1.66E−01 | 1.44E−01 | −2.23E−01 | 7.75E−02 |
| S10* | 1.623 | 0.00E+00 | −3.58E−01 | 1.77E−01 | −1.12E−01 | 4.07E−02 | −6.92E−03 | 6.00E−05 |

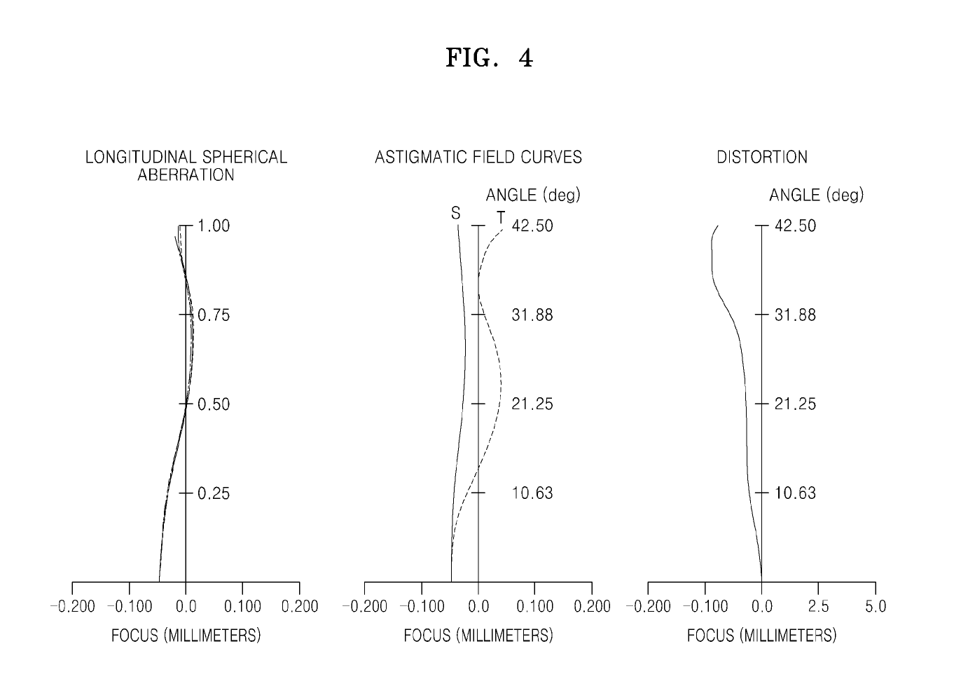

FIG. 4 illustrates longitudinal spherical aberration, astigmatic field curves, and distortion of the photographic lens L according to the second embodiment.

### Third Embodiment

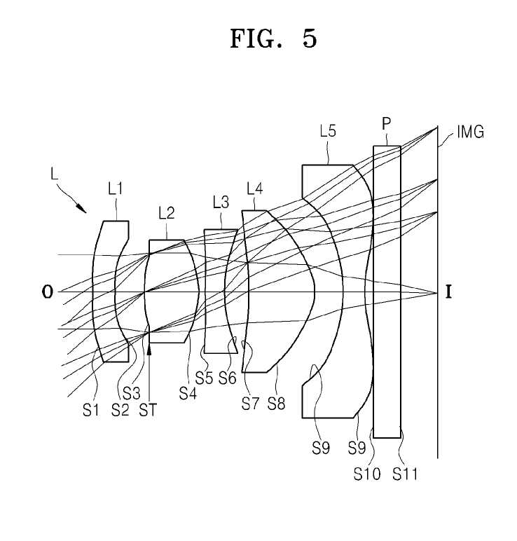

FIG. 5 illustrates a photographic lens L according to a third embodiment, and Table 5 shows design data of the third embodiment.

TABLE 5

| Lens surface | R | Dn | Nd | Vd |
|---|---|---|---|---|
| S1* | 6.404 | 0.250 | 1.532 | 55.7 |
| S2* | 2.174 | 0.340 | | |
| S3* (ST) | 2.047 | 0.600 | 1.545 | 56.1 |
| S4* | −1.055 | 0.073 | | |
| S5* | 8.893 | 0.222 | 1.640 | 23.2 |
| S6* | 1.323 | 0.271 | | |
| S7* | −5.146 | 0.739 | 1.545 | 56.1 |
| S8* | −0.625 | 0.323 | | |
| S9* | −1.262 | 0.250 | 1.569 | 36.1 |
| S10* | 1.619 | 0.096 | | |
| S11 | infinity | 0.300 | 1.517 | 64.2 |
| S12 | infinity | 0.371 | | |
| IMG | | 0.049 | | |

Table 6 below shows aspherical coefficients of the photographic lens L according to the third embodiment.

TABLE 6

| Lens | | | | | | | | |
|---|---|---|---|---|---|---|---|---|
| surface | R | K | A1 | A2 | A3 | A4 | A5 | A6 |
| S1* | 6.404 | 4.98E+01 | 3.02E−01 | −2.25E−01 | −9.41E−02 | 2.78E−01 | −2.57E−01 | −1.05E−01 |
| S2* | 2.174 | 0.00E+00 | 7.02E−01 | −8.45E−01 | 2.66E+00 | −3.53E+00 | 0.00E+00 | 0.00E+00 |
| S3* (ST) | 2.047 | 2.40E+00 | 9.17E−03 | −7.77E−01 | 2.75E+00 | −7.35E+00 | 5.10E−07 | 2.80E−08 |
| S4* | −1.055 | −4.18E+00 | 2.42E−02 | −1.84E+00 | 5.27E+00 | −7.40E−00 | −9.80E−07 | −7.10E−08 |
| S5* | 8.893 | 0.00E+00 | −1.41E−01 | −4.33E−01 | 1.81E+00 | −2.16E+00 | 1.60E−06 | 1.30E−07 |
| S6* | 1.323 | 6.92E−01 | −5.13E−01 | 6.91E−01 | −5.79E−01 | 2.47E−01 | −3.06E−03 | −9.80E−07 |
| S7* | −5.146 | 3.51E+01 | −1.10E−01 | 6.39E−01 | −1.26E+00 | 1.03E+00 | 1.19E−01 | −2.20E−02 |
| S8* | −0.625 | −6.16E−01 | 7.24E−01 | −7.19E−01 | 6.73E−01 | 4.74E−01 | −1.37E+00 | 9.33E−01 |
| S9* | −1.262 | −1.46E+01 | −1.04E−02 | −3.45E−01 | 1.62E−01 | 1.39E−01 | −2.22E−01 | 8.11E−02 |
| S10* | 1.619 | 0.00E+00 | −3.61E−01 | 1.75E−01 | −1.10E−01 | 4.01E−02 | −7.02E−03 | 1.50E−04 |

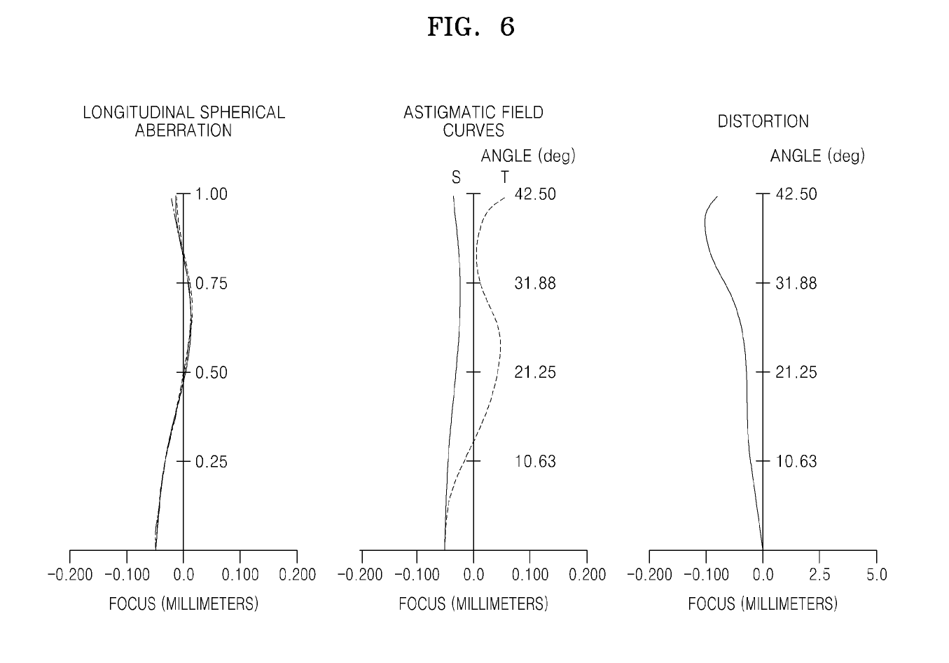

FIG. 6 illustrates longitudinal spherical aberration, astigmatic field curves, and distortion of the photographic lens L according to the third embodiment.

### Fourth Embodiment

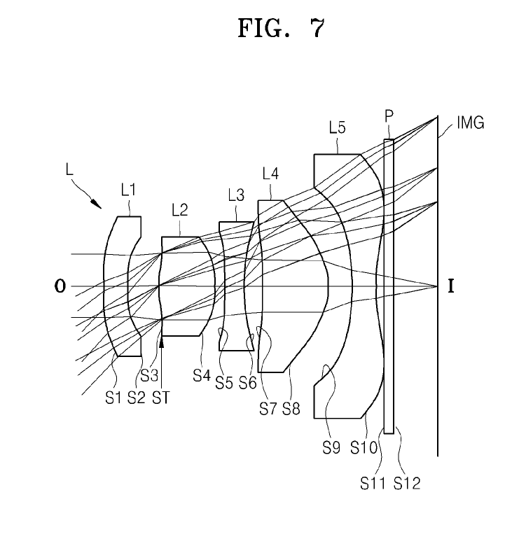

FIG. 7 illustrates a photographic lens L according to a fourth embodiment, and Table 7 shows design data of the fourth embodiment.

TABLE 7

| Lens surface | R | Dn | Nd | Vd |
|---|---|---|---|---|
| S1* | 4.780 | 0.250 | 1.532 | 66.1 |
| S2* | 1.909 | 0.340 | | |
| S3* (ST) | 2.345 | 0.600 | 1.588 | 62.1 |
| S4* | −0.861 | 0.107 | | |
| S5* | −5.524 | 0.200 | 1.755 | 27.6 |
| S6* | 1.700 | 0.196 | | |
| S7* | −4.884 | 0.706 | 1.723 | 46.6 |
| S8* | −0.636 | 0.260 | | |
| S9* | −1.661 | 0.250 | 1.755 | 27.6 |
| S10* | 1.541 | 0.087 | | |
| S11 | infinity | 0.110 | 1.517 | 64.2 |
| S12 | infinity | 0.438 | | |
| IMG | | 0.032 | | |

Table 8 below shows aspherical coefficients of the photographic lens L according to the fourth embodiment.

TABLE 8

| Lens | | | | | | | | |
|---|---|---|---|---|---|---|---|---|
| surface | R | K | A1 | A2 | A3 | A4 | A5 | A6 |
| S1* | 4.780 | 3.00E+01 | 3.99E−01 | −3.46E−01 | −1.60E−02 | 4.82E−01 | −7.18E−01 | −1.05E−01 |
| S2* | 1.909 | 0.00E+00 | 9.04E−01 | −1.12E+00 | 3.93E+00 | −5.35E+00 | 0.00E+00 | 0.00E+00 |
| S3* (ST) | 2.345 | 1.96E+00 | −7.50E−02 | −2.35E+00 | 1.77E+01 | −6.68E+01 | 5.10E−07 | 2.80E−08 |
| S4* | −0.861 | −3.60E+00 | −1.82E−01 | −2.16E+00 | 6.11E+00 | −1.04E+01 | −9.80E−07 | −7.10E−08 |
| S5* | −5.524 | 0.00E+00 | −2.33E−01 | −5.58E−01 | 2.18E+00 | −2.13E+00 | 1.60E−06 | 1.30E−07 |
| S6* | 1.700 | 1.02E+00 | −4.94E−01 | 7.76E−01 | −6.03E−01 | 2.91E−01 | −3.06E−03 | −9.80E−07 |
| S7* | −4.884 | 3.36E+01 | −4.95E−02 | 7.40E−01 | −1.28E+00 | 8.95E−01 | 1.19E−01 | −2.20E−02 |
| S8* | −0.636 | −5.99E−01 | 7.52E−01 | −7.27E−01 | 7.03E−01 | 5.17E−01 | −1.36E+00 | 8.77E−01 |
| S9* | −1.661 | −2.74E+01 | 5.62E−02 | −5.39E−01 | 3.12E−01 | 1.47E−01 | −2.80E−01 | 9.98E−02 |
| S10* | 1.541 | 0.00E+00 | −4.23E−01 | 2.00E−01 | −1.18E−01 | 4.69E−02 | −9.34E−03 | −1.60E−04 |

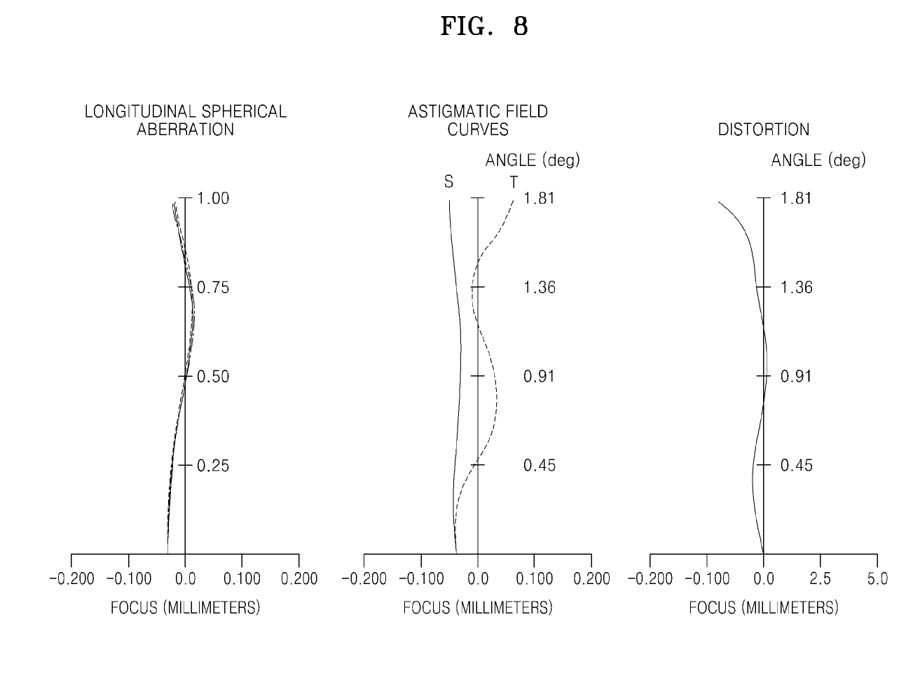

FIG. 8 illustrates longitudinal spherical aberration, astigmatic field curves, and distortion of the photographic lens L according to the fourth embodiment.

### Fifth Embodiment

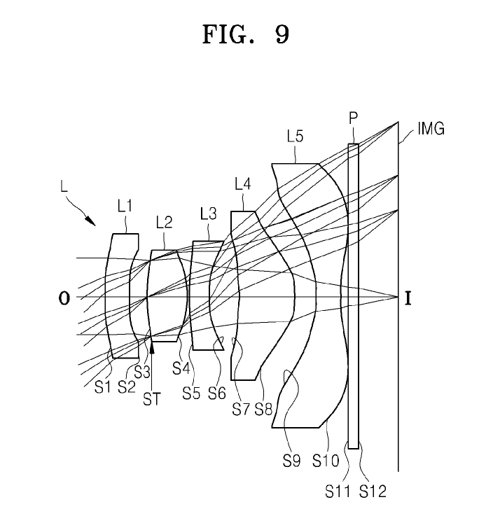

FIG. 9 illustrates a photographic lens L according to a fifth embodiment, and Table 9 shows design data of the fifth embodiment.

TABLE 9

| Lens surface | R | Dn | Nd | Vd |
|---|---|---|---|---|
| S1* | 3.647 | 0.250 | 1.569 | 36.1 |
| S2* | 2.687 | 0.185 | | |
| S3* (ST) | 1.875 | 0.412 | 1.545 | 56.1 |
| S4* | −1.063 | 0.030 | | |
| S5* | 2.622 | 0.200 | 1.640 | 23.2 |
| S6* | 0.979 | 0.313 | | |
| S7* | −2.554 | 0.585 | 1.545 | 56.1 |
| S8* | −0.537 | 0.216 | | |
| S9* | −0.946 | 0.250 | 1.554 | 48.6 |
| S10* | 1.436 | 0.079 | | |
| S11 | infinity | 0.110 | 1.517 | 64.2 |
| S12 | infinity | 0.394 | | |
| IMG | | 0.027 | | |

Table 10 below shows aspherical coefficients of the photographic lens L according to the fifth embodiment.

TABLE 10

| Lens | | | | | | | | |
|---|---|---|---|---|---|---|---|---|
| surface | R | K | A1 | A2 | A3 | A4 | A5 | A6 |
| S1* | 3.647 | 0.00E +00 | 1.66E−01 | 2.61E−01 | −1.15E+00 | 1.30E+00 | −1.25E+00 | −9.67E−01 |
| S2* | 2.687 | 0.00E +00 | 6.81E−01 | −2.71E−01 | 4.41E+00 | −1.35E+01 | −6.21E−03 | 0.00E+00 |
| S3* (ST) | 1.875 | 5.64E+00 | 8.05E−02 | −1.57E+00 | 7.50E+00 | −3.45E+01 | 6.00E−07 | 3.40E−08 |
| S4* | −1.063 | −5.92E+00 | −1.44E−01 | −3.14E+00 | 1.38E+01 | −3.56E+01 | −4.50E−01 | −3.00E−07 |
| S5* | 2.622 | 0.00E +00 | −2.02E−01 | −1.90E−01 | 2.06E+00 | −7.18E+00 | 1.53E−01 | 7.95E−01 |
| S6* | 0.979 | 2.94E−01 | −6.34E−01 | 1.30E+00 | −1.21E+00 | −2.16E+00 | 2.42E+00 | 2.25E+00 |
| S7* | −2.554 | 1.29E+01 | −1.69E−01 | 1.30E+00 | −1.79E+00 | 1.89E +00 | 5.09E−01 | 3.50E−01 |
| S8* | −0.537 | −7.89E−01 | 1.01E+00 | −1.30E+00 | 1.15E+00 | 1.25E+00 | −9.05E−01 | −7.06E−01 |
| S9* | −0.946 | −9.87E+00 | −8.35E−02 | −3.89E−01 | 3.66E−01 | 1.81E−01 | −2.54E−01 | 6.23E−02 |
| S10* | 1.436 | 0.00E+00 | −5.90E−01 | 4.59E−01 | −3.42E−01 | 1.14E−01 | −2.00E−03 | −6.24E−03 |

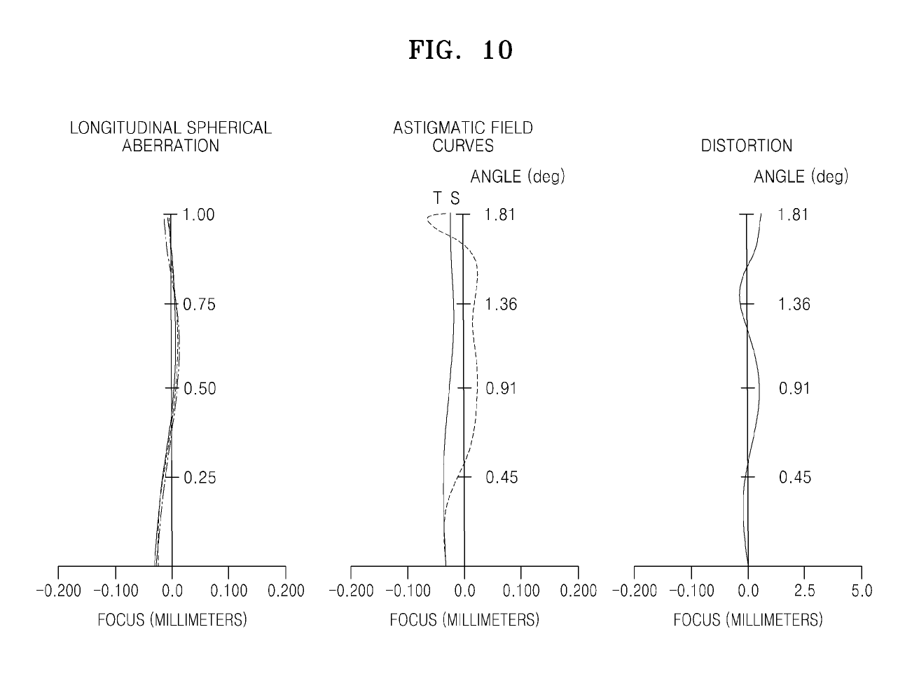

FIG. 10 illustrates longitudinal spherical aberration, astigmatic field curves, and distortion of the photographic lens L according to the fifth embodiment.

The photographic lens L according to the one or more embodiments includes five lenses, each having an appropriate refractive power, so that aberration may be reduced and a total length of the photographic lens may be shortened, and thus, a compact optical system may be realized. Also, since a flare is reduced so that a high resolution image may be obtained, a wide angle of view may be realized. For example, the photographic lens L according to the one or more embodiments may have an angle of view equal to or greater than 80 degrees.

Table 11 below shows data of the photographic lenses L according to the first through fifth embodiments.

TABLE 11

| | First | Second | | | |
|---|---|---|---|---|---|
| | embod- | embod- | Third | Fourth | Fifth |
| Data | iment | iment | embodiment | embodiment | embodiment |
| FoV(°) | 85 | 85 | 85 | 95 | 85 |
| EFL(mm) | 1.99 | 1.98 | 2.02 | 1.67 | 1.96 |
| FNo | 2.45 | 2.45 | 2.45 | 2.45 | 2.45 |
| BFL(mm) | 0.58 | 0.63 | 0.72 | 0.58 | 0.53 |

Table 12 below shows that the photographic lenses L according the first through fifth embodiments satisfy Conditions 1 through 5.

TABLE 12

| | | First | Second | Third | Fourth | Fifth |
|---|---|---|---|---|---|---|
| Condition | | embodiment | embodiment | embodiment | embodiment | embodiment |
| 1 | RS1/RS2 > 1 | 2.89 | 2.96 | 2.95 | 2.50 | 1.36 |
| 2 | 0.5 < FL2/FLA < 1 | 0.68 | 0.68 | 0.68 | 0.69 | 0.66 |
| 3 | 0.1 < FLA/FL23 < 1.1 | 0.86 | 0.87 | 0.88 | 0.72 | 0.93 |
| 4 | V2−V3 > 25 | 32.9 | 32.9 | 32.9 | 34.5 | 32.9 |
| 5 | 5 > TL4/TL3 > 2 | 3.05 | 3.03 | 3.33 | 3.52 | 2.92 |

The photographic lens L according to the one or more embodiments may be applied to an electronic apparatus having an image sensor mounted or housed therein. The photographic lens L according to the one or more embodiments may also be applied to various electronic apparatuses such as digital cameras, interchangeable lens cameras, video cameras, cameras of mobile phones, cameras of small mobile devices, or the like.

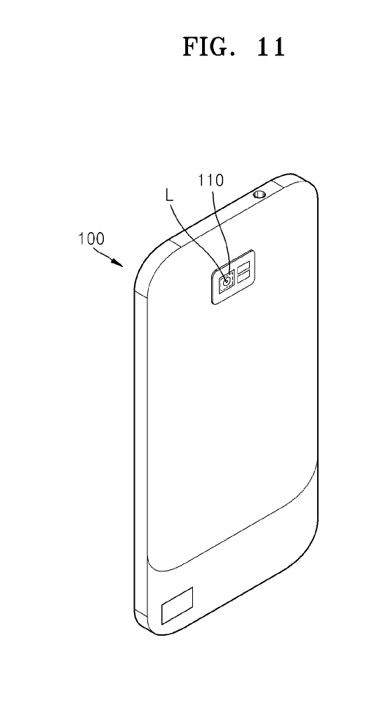

FIG. 11 illustrates an electronic apparatus 100 having the photographic lens L, according to an embodiment. In the embodiment of FIG. 11, the electronic apparatus 100 is applied to a mobile phone but the invention is not limited thereto. The electronic apparatus 100 includes the photographic lens L and an image sensor 110. The image sensor 100 receives an image formed by the photographic lens L and converts the image into an electrical image signal. The photographic lenses L that are described above with reference to FIGS. 1 through 10 may be used as the photographic lens L. By applying the photographic lens L according to the one or more embodiments to an electronic apparatus such as a digital camera, a mobile phone, etc., the electronic apparatus may perform an image-capturing operation with a wide angle and high performance.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. In the description of the embodiments, certain detailed explanations of related art are omitted when it is deemed that they may unnecessarily obscure the essence of the invention.

The use of any and all examples, or exemplary language (e.g., “such as”) provided herein, is intended merely to better illuminate the invention and does not pose a limitation on the scope of the invention unless otherwise claimed. Numerous modifications and adaptations will be readily apparent to those of ordinary skill in this art without departing from the spirit and scope of the invention as defined by the following claims. Therefore, the scope of the invention is defined not by the detailed description of the invention but by the following claims, and all differences within the scope will be construed as being included in the invention.

No item or component is essential to the practice of the invention unless the element is specifically described as “essential” or “critical”. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. Furthermore, recitation of ranges of values herein are merely intended to serve as a shorthand method of referring individually to each separate value falling within the range, unless otherwise indicated herein, and each separate value is incorporated into the specification as if it were individually recited herein.

It should be understood that the exemplary embodiments described therein should be considered in a descriptive sense only and not for purposes of limitation. Descriptions of features or aspects within each embodiment should typically be considered as available for other similar features or aspects in other embodiments.

While one or more embodiments of the present invention have been described with reference to the figures, it will be understood by those of ordinary skill in the art that various changes in form and details may be made therein without departing from the spirit and scope of the present invention as defined by the following claims.

What is claimed is:

1. A photographic lens comprising:
a first lens having a negative refractive power;
a second lens having a positive refractive power;
a third lens having a negative refractive power and an image-side surface that is concave toward an image-side;
a fourth lens having a positive refractive power; and
a fifth lens having a negative refractive power,
wherein the first, second, third, fourth, and fifth lenses are arranged sequentially from an object-side to the image-side, and each of the first, second, third, fourth, and fifth lenses has at least one aspherical surface.

2. The photographic lens of claim 1, further comprising an aperture stop arranged between an object-side of the first lens and the second lens.

3. The photographic lens of claim 1, wherein the photographic lens satisfies the following condition:
RS1/RS2>1,
wherein RS1 is a radius of curvature of an object-side surface of the first lens and RS2 is a radius of curvature of an image-side surface of the first lens.

4. The photographic lens of claim 1, wherein the photographic lens satisfies the following condition:
0.5<FL2/EFL<1,
wherein FL2 is a focal length of the second lens and EFL is an effective focal length of the photographic lens.

5. The photographic lens of claim 1, wherein the photographic lens satisfies the following condition:
0.1<EFL/FL23<1.1,
wherein EFL is an effective focal length of the photographic lens and FL23 is a combined focal length of the second lens and the third lens.

6. The photographic lens of claim 1, wherein the photographic lens satisfies the following condition:
V2−V3>25,
wherein V2 is an Abbe number of the second lens and V3 is an Abbe number of the third lens.

7. The photographic lens of claim 1, wherein the photographic lens satisfies the following condition:
5>TL4/TL3>2,
wherein TL3 indicates a thickness of the third lens and TL4 indicates a thickness of the fourth lens.

8. The photographic lens of claim 1, wherein the fifth lens has an object-side surface that is concave toward the object-side.

9. The photographic lens of claim 1, wherein an image-side surface of the fifth lens has at least one inflection point.

10. The photographic lens of claim 9, wherein the image-side surface of the fifth lens is concave toward the image-side near an optical axis.

11. The photographic lens of claim 1, wherein the photographic lens has an angle of view equal to or greater than 80 degrees.

12. The photographic lens of claim 1, wherein each of the first through fifth lenses has two aspherical lens surfaces.

13. The photographic lens of claim 1, wherein each of the first through fifth lenses is a plastic lens.

14. The photographic lens of claim 1, wherein the third lens is a biconcave lens or a meniscus lens.

15. The photographic lens of claim 1, wherein the first lens is a meniscus lens that is convex toward the object-side.

16. A photographic lens comprising:
a first lens having a negative refractive power;
a second lens having a positive refractive power;
a third lens having a negative refractive power;
a fourth lens having a positive refractive power;
a fifth lens having a negative refractive power; and
an aperture stop arranged between an object-side surface of the first lens and the second lens,
wherein the first, second, third, fourth, and fifth lenses are arranged sequentially from an object-side to an image-side, and each of the first, second, third, fourth, and fifth lenses has at least one aspherical surface.

17. The photographic lens of claim 16, wherein the photographic lens satisfies the following condition:
RS1/RS2>1,
wherein RS1 is a radius of curvature of the object-side surface of the first lens and RS2 is a radius of curvature of an image-side surface of the first lens.

18. The photographic lens of claim 16, wherein the photographic lens satisfies the following condition:
0.5<FL2/EFL<1,
wherein FL2 is a focal length of the second lens and EFL is an effective focal length of the photographic lens.

19. The photographic lens of claim 16, wherein the photographic lens satisfies the following condition:
0.1<EFL/FL23<1.1,
where, EFL is an effective focal length of the photographic lens and FL23 is a combined focal length of the second lens and the third lens.

20. An electronic apparatus comprising:
the photographic lens of claim 1; and
an image sensor that receives light that has passed through the photographic lens and converts the received light into an electrical image signal.
